(19) United States
(12) Patent Application Publication
(10) Pub. No.: US 2025/0201970 A1
(43) Pub. Date: Jun. 19, 2025

(54) SYSTEM FOR MAINTAINING WORKING TEMPERATURE OF ENERGY STORAGE CELLS OF BATTERY MODULES

(71) Applicant: Caterpillar Inc., Peoria, IL (US)

(72) Inventors: Trent Murray, Morton, IL (US); Brian Michael Cole, Dunlap, IL (US); Tyler S. Mullen, Metamora, IL (US); Matthew Ryan Swank, Washington, IL (US)

(73) Assignee: Caterpillar Inc., Peoria, IL (US)

(21) Appl. No.: 18/541,068

(22) Filed: Dec. 15, 2023

(51) Int. Cl. H01M 10/6569; H01M 10/625; H01M 50/209

(52) U.S. Cl. CPC H01M 10/6569; H01M 10/625; H01M 50/209; H01M 2220/20

(57) ABSTRACT

A system, for maintaining a working temperature of an energy storage cell of a battery module, includes a terminal. The terminal includes a heat pipe that defines a head portion and a shank portion. The shank portion is engageable with an electrical tab of the energy storage cell and defines a closed cavity having a hollow structure and a draining structure. Also, the system includes a working fluid contained within the closed cavity. The working fluid is configured to: receive heat from the electrical tab at a region where the shank portion engages with the electrical tab to be vaporized and urged through the hollow structure to reach up to a section of the closed cavity; and release the heat to the head portion at the section of the closed cavity to be condensed and drained through the draining structure to return to the region.

### TECHNICAL FIELD

The present disclosure relates to energy storage cells for battery modules in work machines. More particularly, the present disclosure relates to a system for maintaining a working temperature of energy storage cells of a battery module.

### BACKGROUND

Work machines such as, wheel loaders, and the like machines, are generally equipped with battery modules for powering operations of the work machines. A battery module typically includes multiple rechargeable energy storage cells, such as, lithium-ion prismatic cells. Each of these energy storage cells generally include electrodes (e.g., positive electrodes and negative electrodes) and at least two electrical tabs connected (e.g., welded or soldered) to their corresponding electrodes.

During an exemplary charging and/or discharging process, such as when powering an operation of a work machine is in progress, the energy storage cells generate heat at connections between the electrical tabs and their corresponding electrodes. Such heat, in excess, may lead to overheating of the energy storage cells, which may affect the performance and overall life of these energy storage cells.

U.S. Pat. No. 6,010,800 discloses an apparatus and a method for controlling temperature of a battery. The apparatus includes a thermal conductor, such as a thermally-conductive heat pipe or forced-fluid cooling loop, that is in thermal contact with thermally-conductive cell terminals of the battery, and a interior volume heat sink, such as a radiator. The method includes operating the battery to generate and conduct heat to the thermally-conductive battery cell terminals. The generated heat is passed via conduction from the terminals to the thermal conductor. The heat is conducted through the thermal conductor to a heat sink which may be remotely located with respect to the battery. Preferably, the thermal conductor remains electrically insulated from the battery cell terminals and the heat sink.

### SUMMARY OF THE INVENTION

In one aspect, the disclosure relates to a system for maintaining a working temperature of an energy storage cell of a battery module. The system includes a terminal. The terminal includes a heat pipe that defines a head portion and a shank portion. The shank portion is engageable with an electrical tab of the energy storage cell. The shank portion defines a closed cavity having a hollow structure and a draining structure. Also, the system includes a working fluid contained within the closed cavity. The working fluid is configured to receive heat from the electrical tab at a region where the shank portion engages with the electrical tab to be vaporized and urged through the hollow structure to reach up to a section of the closed cavity. In addition, the working fluid is configured to release the heat to the head portion at the section of the closed cavity to be condensed and drained through the draining structure to return to the region.

In another aspect, the disclosure is directed to an energy storage cell of a battery module used in a work machine. The energy storage cell includes one or more electrodes, at least one electrical tab electrically coupled to the one or more electrodes, and a system for maintaining a working temperature of the energy storage cell. The system includes a terminal. The terminal includes a heat pipe that defines a head portion and a shank portion. The shank portion is engageable with the electrical tab of the energy storage cell. The shank portion defines a closed cavity having a hollow structure and a draining structure. Also, the system includes a working fluid contained within the closed cavity. The working fluid is configured to receive heat from the electrical tab at a region where the shank portion engages with the electrical tab to be vaporized and urged through the hollow structure to reach up to a section of the closed cavity. In addition, the working fluid is configured to release the heat to the head portion at the section of the closed cavity to be condensed and drained through the draining structure to return to the region.

In yet another aspect, the disclosure relates to a battery module for a work machine. The battery module includes a casing. The casing defines an interior volume and a plurality of walls surrounding the interior volume. The at least one wall of the plurality of walls provides a heat sink. Further, the battery module includes a plurality of energy storage cells disposed in the interior volume of the casing. An energy storage cell, of the plurality of energy storage cells, includes one or more electrodes, at least one electrical tab electrically coupled to the one or more electrodes, and a system for maintaining a working temperature of the energy storage cell. The system includes a terminal. The terminal includes a heat pipe that defines a head portion and a shank portion. The shank portion is engageable with the electrical tab of the energy storage cell. The shank portion defines a closed cavity having a hollow structure and a draining structure. Also, the system includes a working fluid contained within the closed cavity. The working fluid is configured to receive heat from the electrical tab at a region where the shank portion engages with the electrical tab to be vaporized and urged through the hollow structure to reach up to a section of the closed cavity. In addition, the working fluid is configured to release the heat to the head portion at the section of the closed cavity to be condensed and drained through the draining structure to return to the region.

### BRIEF DESCRIPTION OF THE DRAWINGS

FIG. 1 illustrates an exemplary work machine including a battery pack, in accordance with an embodiment of the present disclosure;

FIG. 2 illustrates the battery pack having two battery modules, each including a plurality of energy storage cells, in accordance with an embodiment of the present disclosure;

FIG. 3 illustrates a system for maintaining a working temperature of the energy storage cell, in accordance with an embodiment of the present disclosure;

FIG. 4 illustrates a cross-sectional view of the system, in accordance with an embodiment of the present disclosure; and

FIG. 5 illustrates a cross-sectional view of the battery module, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

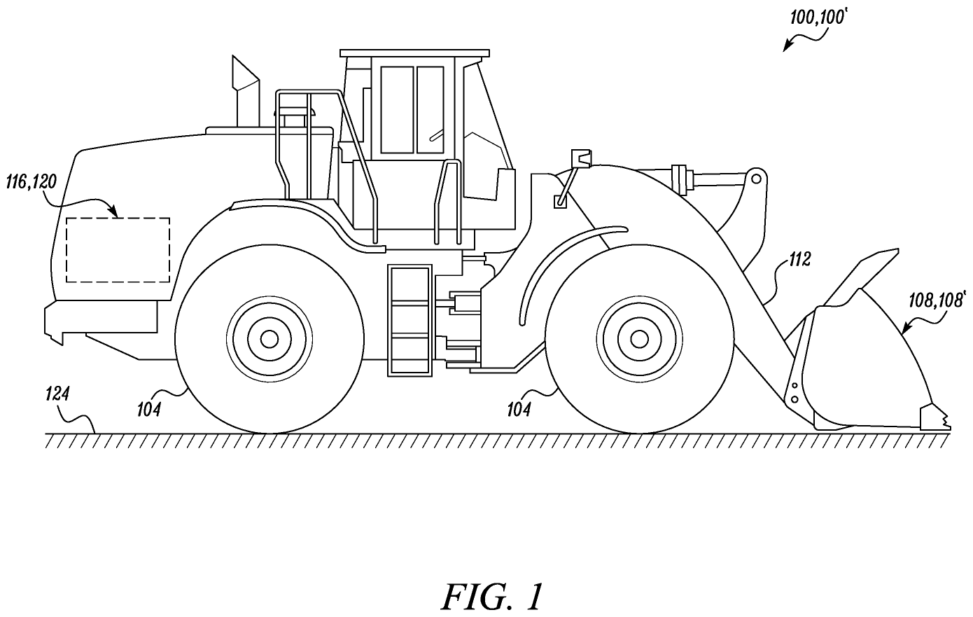

Referring to FIG. 1, a machine 100 is illustrated. As exemplarily depicted, the machine 100 includes a construction machine, and may include a loader machine, such as a wheel loader 100′. However, it may be contemplated that the machine 100 may be of any type which may be configured to perform operations associated with an industry, such as, mining, construction, farming, and transportation. An application of one or more aspects of the present disclosure may be extended to stationary machines, such as generator sets, as well. Therefore, it will be appreciated that references to the machine 100 is exemplary. Other examples of machine 100 may include, but are not limited to, an off-highway truck, an articulated truck, a paver, an excavator, a backhoe loader, a skid steer loader, a compactor. As shown in FIG. 1, the machine 100 includes a set of ground engaging members 104 (such as, wheels), an implement 108 (such as, a bucket 108′), and a pair of movable lift arms 112 that may be applied to manipulate the implement 108.

The machine 100 may include a power source 116 that may provide power to operate the machine 100. The power source 116 may include battery packs, such as a battery pack 120. The battery pack 120 may be applied to supply power to the ground engaging members 104, for example, to move the machine 100 over a ground surface 124. The battery pack 120 may also be used to supply power to operate the implement 108 and perform various other operations of the machine 100. In some embodiments, the battery pack 120 may work in conjunction with one or more additional power sources (not shown), such as an internal combustion engine, an electric generator, a turbine, or any other suitable device, by which power may be produced and then supplied to perform one or more of the operations of the machine 100.

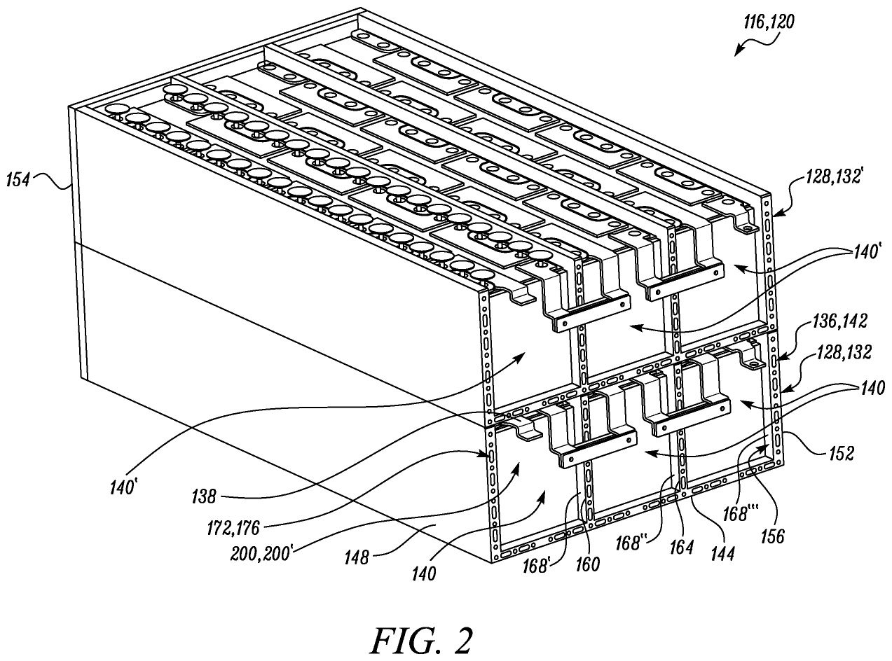

The battery pack 120 may include multiple battery modules 128. In an example, as shown in FIG. 2, the battery pack 120 includes two battery modules 128, namely—a first battery module 132 and a second battery module 132. The first battery module 132 and the second battery module 132′ may be arranged in a stacked relationship (as shown in FIG. 2) and may be electrically coupled to one another to provide a desired power output and voltage output for the machine 100. It may be contemplated that, in other embodiments, the battery pack 120 may include a higher or lower number of battery modules depending on a power requirements of the machine 100.

For explanatory purposes, the first battery module 132 (hereinafter referred to as the “battery module 132”) will now be explained in detail with reference to FIGS. 2-5. However, it should be noted that the description provided below for the battery module 132 is equally applicable to the second battery module 132′, or other battery modules of the battery pack 120, without any limitations. The battery module 132 includes a casing 136 and multiple energy storage cells 140. The battery module 132 may also include one or more electrical and/or electronic components, such as busbars 138, a battery management system (not shown), and the like. Such electrical and/or electronic components and their functionality are known in the art, and therefore, they are not discussed, for the sake of brevity.

By way of non-limiting example, the casing 136 may be embodied as a substantially cuboid shaped structure 142 that defines a plurality of walls, namely—a base wall 144, a first side wall 148, a second side wall 152, a front wall (not shown in FIG. 2 in order to illustrate the energy storage cells 140 within the casing 136), and a rear wall 154. The first side wall 148 and the second side wall 152 may be substantially parallel to one another. The first side wall 148 and the second side wall 152 may extend at an angle from the base wall 144, for example, substantially perpendicular to the base wall 144. The base wall 144, the first side wall 148, the second side wall 152, the front wall, and the rear wall 154 may be arranged (or coupled) together to define and surround an interior volume 156 of the casing 136.

In the present exemplary embodiment, as shown in FIG. 2, the casing 136 also defines two intermediate walls, namely—a first intermediate wall 160 and a second intermediate wall 164. The first intermediate wall 160 and the second intermediate wall 164 extend from the base wall 144, between the front wall and the rear wall 154. The first intermediate wall 160 and a second intermediate wall 164 are spaced from and substantially parallel to each other. In addition, the first intermediate wall 160 and a second intermediate wall 164 are spaced from and substantially parallel to the first side wall 148 and the second side wall 152, dividing the interior volume 156 into three racks, namely—a first rack 168′, a second rack 168″, and a third rack 168′″. It may be contemplated that, in other embodiments, the casing 136 may define a higher or a lower number of intermediate walls and accordingly, a higher or lower number of racks.

The casing 136 is provided with a heat sink 172. The heat sink 172 may facilitate removal of heat from the energy storage cells 140. The heat sink 172 may include one or more cooling passages, such as a cooling passage 176. The heat sink 172 (e.g., the cooling passages 176) may be defined on at least one wall of the casing 136. In the present embodiment, as shown in FIG. 2, multiple cooling passages 176 are defined on each of the base wall 144, the first side wall 148, the second side wall 152, the first intermediate wall 160, and the second intermediate wall 164.

Each cooling passage 176 may be configured to route a coolant therethrough such that the coolant may absorb the heat released from the energy storage cells 140. The cooling passage 176 may be in fluid communication with one or more coolant supply and discharge systems associated with the machine 100, for receiving cooled coolant supply and discharging hot coolant therefrom. Examples of the coolant may include, but not limited to, water, glycol, a water/glycol mixture, and oil.

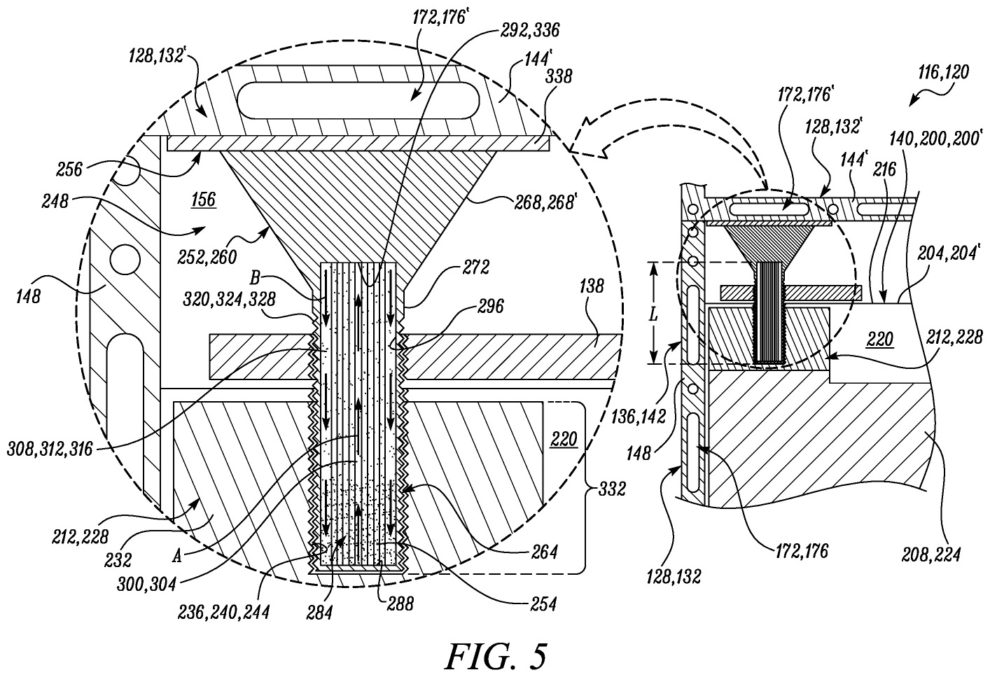

It should be noted that, although the depicted heat sink 172 is described to include the cooling passage(s) 176 as shown in FIGS. 2 and 5, the heat sink 172 may include any known heat radiating structure, such as, for example, fins formed on external surface(s) of at least one wall of the casing 136 and configured to transfer the heat (from the energy storage cells 140) to the cooling fluid (e.g., ambient air) passing over and between the fins.

The energy storage cells 140 are disposed in the interior volume 156 of the casing 136. In an example, as shown in FIG. 2, multiple energy storage cells 140 are arranged (and/or stacked) within each of the first rack 168, the second rack 168″, and the third rack 168′″. In an example, nineteen energy storage cells are arranged within each of the first rack 168, the second rack 168″, and the third rack 168′″. The arrangement of the energy storage cells 140 shown in FIG. 2 is not exclusive, and additional configurations, and arrangements of the energy storage cells 140 within the interior volume 156 of the casing 136 are also contemplated.

For explanatory purposes, an energy storage cell 200 (of the multiple energy storage cells 140 arranged in the first rack 168′ of the casing 136) will now be explained in detail with reference to FIGS. 2 and 5. However, it should be noted that the description provided below for the energy storage cell 200 is equally applicable to the other energy storage cells 140, of the battery module 132 (as well as of the second battery module 132′) without any limitations.

The energy storage cell 200 is an electrochemical cell 200′. Examples of the electrochemical cell 200′ may include, but need not be limited to, a lithium-ion cell, such as, a lithium cobalt oxide cell, a lithium manganese oxide cell, a lithium nickel manganese cobalt oxide cell, a lithium iron phosphate cell, a lithium nickel cobalt aluminum oxide cell, and a lithium titanate cell. The energy storage cell 200 includes a housing 204, one or more electrodes 208, and at least one electrical tab 212. The energy storage cell 200 may also include other cell components, such as separators (not shown), electrolyte (not shown), and the like. Such cell components and their functionality are known in the art, and therefore, they are not discussed, for the sake of brevity. Each of the housing 204, the electrodes 208, and the electrical tabs 212 is now discussed in detail.

The housing 204 may be embodied as a substantially prismatic shaped structure 204′. The prismatic shaped structure 204′ may define two rectangular bases (only one rectangular base 216 is shown in FIG. 5), four lateral faces extending between the two rectangular bases, and an inner volume 220. The housing 204 may be formed of any suitable metals, or alloys, or non-metals, or composites.

The electrodes 208 may include one or more positive electrodes (or cathodes) 224 and one or more negative electrodes (or anodes) (not shown). In an exemplary embodiment, as shown in FIG. 5, the positive electrode(s) 224 and the negative electrode(s) may be fabricated as a foil. It may be contemplated that, in other embodiments, the positive electrode(s) 224 and the negative electrode(s) may be fabricated as a plate, or a wire, or a bar, or a mesh, or any suitable structure.

In an example, a positive electrode 224 may be fabricated by making a positive electrode collector using aluminum, nickel, copper, or an alloy including at least one of aluminum, nickel, and copper, and coating the positive electrode collector with a positive electrode active material such as a lithium manganese oxide, a lithium cobalt oxide, a lithium nickel oxide, a lithium iron phosphate, or a compound or mixture including at least one thereof. In addition, a negative electrode may be fabricated by making a negative electrode collector using copper, nickel, aluminum, or an alloy including at least one of copper, nickel, and aluminum, and coating the negative electrode collector with a negative electrode active material such as lithium, a lithium alloy, carbon, petroleum coke, active carbon, graphite, a silicon compound, a zinc compound, a titanium compound, or an alloy thereof. In an exemplary embodiment, the positive electrode 224 is fabricated by using an aluminum foil as a positive electrode collector and coating the aluminum foil with lithium cobalt oxide whereas, the negative electrode is fabricated by using a copper foil as a negative electrode collector and coating the copper foil with graphite.

The electrodes 208 may be accommodated in the inner volume 220 of the housing 204. The electrodes 208 (i.e., the positive electrode(s) 224 and the negative electrode(s)) may be arranged in any known configuration such as, a jelly-roll (wound) configuration, or a stacked configuration, or a laminated configuration, or a stacked and folded type (composite type) configuration, and the like.

The energy storage cell 200 includes two electrical tabs 212, namely, a first electrical tab 228 and a second electrical tab (not shown). The first electrical tab 228 includes a body 232. The body 232 may be accommodated within the housing 204 of the energy storage cell 200. The body 232 may be fabricated by using a suitable electrically conductive metal, or its alloys. In an exemplary embodiment, the body 232 of the first electrical tab 228 is formed of aluminum metal. The body 232 may include a hole 236. The hole 236 may define an engagement portion 240. In an exemplary embodiment, as shown in FIG. 5, the engagement portion 240 includes an internal threaded surface 244.

The first electrical tab 228 is configured to be electrically coupled to one or more electrodes 208. In an exemplary embodiment, as shown in FIG. 5, the first electrical tab 228 is coupled (e.g., welded or soldered) to one or more of the positive electrodes 224 to establish an electrical connection between the one or more of the positive electrodes 224 and an external circuit (e.g., busbar 138) associated with the battery pack 120 of the machine 100.

The second electrical tab (not shown) may have a construction similar to the construction of the first electrical tab 228, except that the second electrical tab may be formed of copper metal instead of aluminum metal. In the present embodiment, the second electrical tab is coupled (e.g., welded or soldered) to one or more of the negative electrodes (not shown) of the energy storage cell 200 to establish an electrical connection between the one or more of the negative electrodes and an external circuit (not shown) associated with the battery pack 120 of the machine 100.

In operation (e.g., when charging or discharging), the energy storage cell 200 (of the energy storage cells 140) generates heat, for example, due to internal electrical resistances at or near connections between the electrical tabs 212 and their corresponding electrodes 208. Such heat, in excess, may lead to overheating of the energy storage cell 200, which may affect the performance and overall life of the energy storage cells 140, the battery modules 132, 132′, and the battery pack 120. To ensure a safe, controlled, and efficient operation of the battery pack 120, temperature of each of the energy storage cells 140 should be maintained within a certain range of temperature, i.e., the working temperature.

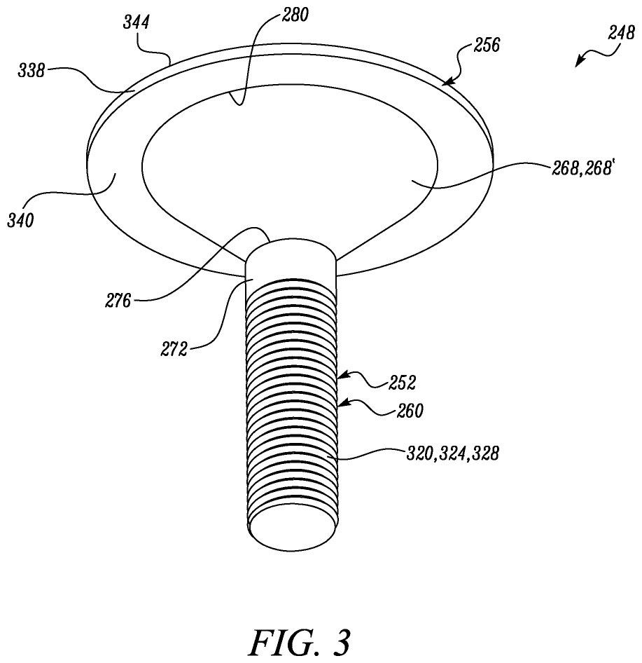

In order to maintain a working temperature of the energy storage cell 200 (of the energy storage cells 140), in one or more aspect of the present disclosure, the energy storage cell 200 is provided with a system 248. The system 248 includes a terminal 252 and a working fluid 254 (shown in FIG. 5). Also, the system 248 may include an electrically-insulating, thermally-conducting pad 256. Each of the terminal 252, the working fluid 254, and the electrically-insulating, thermally-conducting pad 256 will now be discussed in detail with reference to FIGS. 3-5.

Two terminals 252, namely—a first terminal 260 and a second terminal (not shown) may be provided on the energy storage cell 200. The first terminal 260 may be configured to be coupled to the first electrical tab 228, as shown in FIG. 5, to facilitate transfer of electrical current between the first electrical tab 228 and the external circuit (e.g., the busbar 138) of the battery pack 120. Similarly, the second terminal (not shown) may be configured to be coupled to the second electrical tab (not shown) to facilitate transfer of electrical current between the second electrical tab and an external circuit of the battery pack 120.

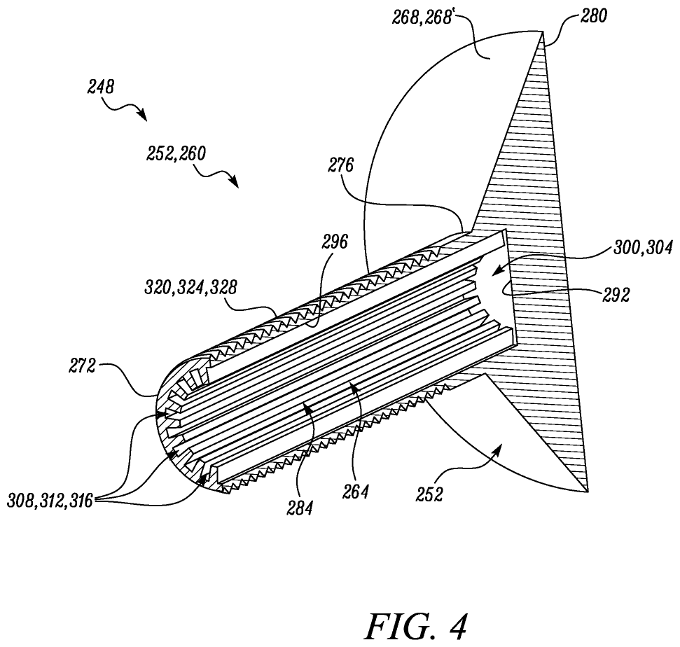

For explanatory purposes, the first terminal 260 (hereinafter referred to as the “terminal 260”) will now be explained in detail with reference to FIGS. 3-5. However, it should be noted that the description provided below for the terminal 260 is equally applicable to the second terminal, without any limitations. The terminal 260 includes a heat pipe 264 (shown in FIGS. 4 and 5). The heat pipe 264 defines a head portion 268 and a shank portion 272.

The head portion 268 may have a frustoconical shape 268′. The frustoconical shape 268′ may define a first cross-sectional area (or base) 276 and a second cross-sectional area (or base) 280, as shown in FIG. 3. The first cross-sectional area (or base) 276 may be disposed towards the shank portion 272 and the second cross-sectional area 280 may be disposed away from the shank portion 272. In such a configuration, the first cross-sectional area (or base) 276 may be disposed closer to the shank portion 272 than the second cross-sectional area 280. Further, each of the first cross-sectional area (or base) 276 and the second cross-sectional area (or base) 280 may define a circular profile. However, it may be contemplated that, in other embodiments, the first cross-sectional area (or base) 276 and the second cross-sectional area (or base) 280 may define any suitable profiles or shapes. Furthermore, the second cross-sectional area (or base) 276 may be greater than the first cross-sectional area (or base) 276.

The shank portion 272 may extend outwardly from the first cross-sectional area (or base) 276 of the head portion 268. The shank portion 272 defines a closed cavity 284 (shown in FIGS. 4 and 5). It should be noted that the term “closed cavity” may refer to a cavity through which substantially no fluid masses can be exchanged with an environment external to the cavity. The closed cavity 284 defines a first end surface 288, a second end surface 292 spaced from the first end surface 288, and an interior surface 296 extending between the first end surface 288 and the second end surface 292 to define a volume 300 of the closed cavity 284.

Further, the closed cavity 284 defines a hollow structure 304 and a draining structure 308. The hollow structure 304 may be defined by the volume 300 of the closed cavity 284. The draining structure 308 may be defined along the interior surface 296 of the closed cavity 284. The draining structure 308 may at least partially surround the hollow structure 304. In an exemplary embodiment, the draining structure 308 fully surrounds the hollow structure 304. The draining structure 308 may include an array 312 of channels. Each channel 316 of the array 312 may extend along a length ‘L’ of the closed cavity 284 between the first end surface 288 and the second end surface 292. In the present embodiment, as shown in FIG. 5, the closed cavity 284 extends at least partially into the head portion 268 of the heat pipe 264. In this configuration, the second end surface 292 of the closed cavity 284 may be disposed in the head portion 268 of the heat pipe 264. In other embodiments, the closed cavity 284 may extend along the shank portion 272 of the heat pipe 264 but not into the head portion 268 of the heat pipe 264.

The shank portion 272 is engageable with the at least one electrical tab 212, for example, with the first electrical tab 228 (as shown in FIG. 5). In the present embodiment, the shank portion 272 includes an external surface 320 that defines a mating portion 324. The mating portion 324 may be engageable with the engagement portion 240 of the first electrical tab 228. In an example, as shown in FIG. 3, the mating portion 324 may be embodied as an external threaded portion 328 configured to be engaged with the internal threaded surface 244 of the first electrical tab 228, to engage the shank portion 272 with the first electrical tab 228.

The working fluid 254 is now discussed. The working fluid 254 is contained within the closed cavity 284 of the heat pipe 264. The working fluid 254 may be in both a pure liquid form and a pure vapor form. In an example, the working fluid 254 may include a methanol-based fluid, which has a low boiling point. In another example, the working fluid 254 may include a water-based fluid. The working fluid 254 is configured to vaporize upon receipt of heat, for example, from the first electrical tab 228 at a region 332 (defined towards the first end surface 288) where the shank portion 272 engages with the first electrical tab 228. Upon receipt of the heat, the working fluid 254, in the vapor form, urges through the hollow structure 304 (in a direction ‘A’) to reach up to a section 336 (e.g., the second end surface 292) of the closed cavity 284. Once reached at the section 336, the working fluid 254 is configured to release the heat to the head portion 268 to be condensed and drained through the draining structure 308 (e.g., through the channels 316) to return (in a direction ‘B’) to the region 332 of the closed cavity 284.

The electrically-insulating, thermally-conducting pad 256 may be formed of a silicone-based material. The electrically-insulating, thermally-conducting pad 256 may include a body 338 defining two opposite surfaces, namely—a first surface 340 and a second surface 344 (shown in FIG. 3). Each of the first surface 340 and the second surface 344 defines a flat, circular profile. In an exemplary embodiment, as shown in FIG. 3, each of the first surface 340 and the second surface 344 has a surface area greater than that of the second cross-sectional area (or base) 280 of the head portion 268. It may be noted that, in other embodiments, the surface area of the first surface 340 and the second surface 344 may be equal to or lower than that of the second cross-sectional area (or base) 280.

The electrically-insulating, thermally-conducting pad 256 is configured to be in thermal contact with the head portion 268 and the heat sink 172. to transfer the heat from the head portion 268 to the heat sink 172. For that, as shown in FIG. 5, the electrically-insulating, thermally-conducting pad 256 may be disposed between the head portion 268 (of the heat pipe 264) and the heat sink 172 (e.g., a cooling passage 176′ defined on a base wall 144′ of the casing 136′ associated with the second battery module 132′). In this configuration, the first surface 340 may be disposed towards the second cross-sectional area (or base) 280 of the head portion 268 and, the second surface 344 may be disposed towards the heat sink 172.

### INDUSTRIAL APPLICABILITY

An exemplary process of maintaining the working temperature of the energy storage cell 200, is discussed. The method is discussed in conjunction with FIGS. 1-5. Initially, the working fluid 254 contained within the closed cavity 284 (of the heat pipe 264) may exist both in the liquid form and the vapor form. During a charge/discharge cycle, the energy storage cell 200 may generate heat, for example, due to internal electrical resistances at or near connections between the electrical tab 228 and the electrodes 208 (e.g., the positive electrode(s) 224). The heat generated by the energy storage cell 200 may be received by the working fluid 254 at the region where the shank portion 272 engages with the first electrical tab 228. The working fluid 254 may absorb this heat as a latent heat of vaporization to be vaporized and urged (as shown in the direction ‘A’) through the hollow structure 304 to reach up to the section 336 (e.g., the second end surface 292) of the closed cavity 284.

At the section 336, the working fluid 254, in its vapor form, may release the heat (i.e., the latent heat of vaporization) to the head portion 268, to be condensed back into the liquid state. The working fluid 254, in its liquid form, may be drained through the draining structure 308 (e.g., the channels 316), as shown in the direction ‘B’, to return to the region 332 of the closed cavity 284. At the region 332, the returned working fluid 254, in its liquid form, may be vaporized further to transfer the heat from the region 332 (which may be proximate to or surrounded by the electrical tab 228) to the section 336 (which may be proximate to the heat sink 172.

The heat absorbed by the head portion 268 (of the heat pipe 264) may be further transferred to the electrically-insulating, thermally-conducting pad 256. Furthermore, the heat absorbed by the electrically-insulating, thermally-conducting pad 256 may be transferred to the heat sink 172, e.g., to the coolant flowing through the cooling passage 176′ defined on the base wall 144′ of the casing 136′ associated with the second battery module 132′, as shown in FIG. 5). In this manner, the heat released from the energy storage cell 200 can be transferred away from the energy storage cell 200, thereby cooling the energy storage cell 200.

The system 248 may be retrofittable to any type of energy storage cell having at least one electrical tab 212 with a hole for receiving a terminal (e.g., conventional terminal screws) of the energy storage cell, such as the electrical tab 228 with the hole 236. The at least one terminal 252 (e.g., the terminal 260) of the system 248 may facilitate transfer of the electrical current between the energy storage cell 200 and the external circuit (e.g., the busbar 138) of the battery module 132. In addition, the heat pipe 264 provided within the at least one terminal 252 (e.g., the terminal 260) along with the electrically-insulating, thermally-conducting pad 256 may facilitate conduction and dissipation of heat generated by the energy storage cell 200 to the heat sink 172, thereby maintaining the working temperature of the energy storage cell 200. Furthermore, utilizing the head portion 268 of the heat pipe 264 and the electrically-insulating, thermally-conducting pad 256 may result in high heat conduction and dissipation between the energy storage cell 200 and the heat sink 172. Accordingly, the system 248 may prevent the energy storage cells from overheating, and hence provide a simple and cost-effective solution for cooling and/or maintaining the working temperature of the energy storage cells of the battery modules of the machines.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the system, the energy storage cell, and/or the battery module of the present disclosure without departing from the scope of the disclosure. Other embodiments will be apparent to those skilled in the art from consideration of the specification and practice of the system, the energy storage cell, and/or the battery module disclosed herein. It is intended that the specification and examples be considered as exemplary only, with a true scope of the disclosure being indicated by the following claims and their equivalent.

What is claimed is:

1. A system for maintaining a working temperature of an energy storage cell of a battery module, the system comprising:
a terminal including a heat pipe defining a head portion and a shank portion, the shank portion engageable with an electrical tab of the energy storage cell and defining a closed cavity having a hollow structure and a draining structure; and
a working fluid contained within the closed cavity, the working fluid configured to:
receive heat from the electrical tab at a region where the shank portion engages with the electrical tab to be vaporized and urged through the hollow structure to reach up to a section of the closed cavity, and
release the heat to the head portion at the section of the closed cavity to be condensed and drained through the draining structure to return to the region.

2. The system of claim 1, wherein the draining structure is defined along an interior surface of the closed cavity to at least partially surrounds the hollow structure.

3. The system of claim 1, wherein the draining structure includes an array of channels extending along a length of the closed cavity between the region and the section of the closed cavity.

4. The system of claim 1, wherein the closed cavity extends at least partially into the head portion of the heat pipe.

5. The system of claim 1 further comprising an electrically-insulating, thermally-conducting pad configured to be in thermal contact with the head portion of the heat pipe and a heat sink of the battery module to transfer the heat from the head portion to the heat sink.

6. The system of claim 1, wherein the electrical tab includes a hole defining an engagement portion, and the shank portion includes an external surface defining a mating portion engageable with the engagement portion to engage the terminal with the electrical tab.

7. The system of claim 1, wherein the head portion has a frustoconical shape defining a first cross-sectional area disposed towards the shank portion of the heat pipe and a second cross-sectional area disposed away from the shank portion of the heat pipe, and wherein the second cross-sectional area is greater than the first cross-sectional area.

8. An energy storage cell of a battery module used in a work machine, the energy storage cell comprising:
one or more electrodes;
at least one electrical tab electrically coupled to the one or more electrodes; and
a system for maintaining a working temperature of the energy storage cell, the system including:
a terminal including a heat pipe defining a head portion and a shank portion, the shank portion engageable with the at least one electrical tab and defining a closed cavity having a hollow structure and a draining structure; and
a working fluid contained within the closed cavity, the working fluid configured to:
receive heat from the at least one electrical tab at a region where the shank portion engages with the at least one electrical tab to be vaporized and urged through the hollow structure to reach up to a section of the closed cavity, and
release the heat to the head portion at the section of the closed cavity to be condensed and drained through the draining structure to return to the region.

9. The energy storage cell of claim 8, wherein the draining structure is defined along an interior surface of the closed cavity to at least partially surrounds the hollow structure.

10. The energy storage cell of claim 8, wherein the draining structure includes an array of channels extending along a length of the closed cavity between the region and the section of the closed cavity.

11. The energy storage cell of claim 8, wherein the closed cavity extends at least partially into the head portion of the heat pipe.

12. The energy storage cell of claim 8, wherein the system includes an electrically-insulating, thermally-conducting pad configured to be in thermal contact with the head portion of the heat pipe and a heat sink of the battery module to transfer the heat from the head portion to the heat sink.

13. The energy storage cell of claim 8, wherein the at least one electrical tab includes a hole defining an engagement portion, and the shank portion includes an external surface defining a mating portion engageable with the engagement portion to engage the terminal with the at least one electrical tab.

14. The energy storage cell of claim 8, wherein the head portion has a frustoconical shape defining a first cross-sectional area disposed towards the shank portion of the heat pipe and a second cross-sectional area disposed away from the shank portion of the heat pipe, and wherein the second cross-sectional area is greater than the first cross-sectional area.

15. A battery module for a work machine, the battery module comprising:
a casing defining an interior volume and a plurality of walls surrounding the interior volume, at least one wall of the plurality of walls providing a heat sink;
a plurality of energy storage cells disposed in the interior volume, each of the energy storage cells including:
one or more electrodes;
at least one electrical tab electrically coupled to the one or more electrodes; and
a system for maintaining a working temperature of the energy storage cell, the system including:
a terminal including a heat pipe defining a head portion and a shank portion, the shank portion engageable with the at least one electrical tab and defining a closed cavity having a hollow structure and a draining structure; and
a working fluid contained within the closed cavity, the working fluid configured to:
receive heat from the at least one electrical tab at a region where the shank portion engages with the at least one electrical tab to be vaporized and urged through the hollow structure to reach up to a section of the closed cavity, and
release the heat to the head portion at the section of the closed cavity to be condensed and drained through the draining structure to return to the region.

16. The battery module of claim 15, wherein the draining structure is defined along an interior surface of the closed cavity to at least partially surrounds the hollow structure, and wherein the draining structure includes an array of channels extending along a length of the closed cavity between the region and the section of the closed cavity.

17. The battery module of claim 15, wherein the closed cavity extends at least partially into the head portion of the heat pipe.

18. The battery module of claim 15, wherein the system includes an electrically-insulating, thermally-conducting pad configured to be in thermal contact with the head portion of the heat pipe and the heat sink to transfer the heat from the head portion to the heat sink.

19. The battery module of claim 18, wherein the heat sink includes one or more cooling passages formed in the at least one wall of the casing, the one or more cooling passages being configured to route a coolant therethrough such that the coolant absorbs the heat transferred through the electrically-insulating, thermally-conducting pad.

20. The battery module of claim 15, wherein the head portion has a frustoconical shape defining a first cross-sectional area disposed towards the shank portion of the heat pipe and a second cross-sectional area disposed away from the shank portion of the heat pipe, and wherein the second cross-sectional area is greater than the first cross-sectional area.
